(19) United States
(12) Patent Application Publication
(10) Pub. No.: US 2008/0314329 A1
(43) Pub. Date: Dec. 25, 2008

(54) BIRDCAGE FEEDER

(75) Inventors: Jonathan Willinger, Tenafly, NJ (US); Peter Ragonetti, Brooklyn, NY (US); Klaus Woltman, Demarest, NJ (US)

Correspondence Address: KATTEN MUCHIN ROSENMAN LLP, 575 MADISON AVENUE, NEW YORK, NY, 10022-2585, US

(73) Assignee: JW PET COMPANY, INC., Teterboro, NJ (US)

(21) Appl. No.: 12/164,337

(22) Filed: Jun. 30, 2008

Related U.S. Application Data
(63) Continuation-in-part of application No. 11/542,615, filed on Oct. 3, 2006.
Application No. 11/542,615 is a continuation-in-part of application No. 10/910,242, filed on Aug. 3, 2004, now Pat. No. 7,392,763.
Application No. 10/910,242 is a continuation-in-part of application No. 11/087,728, filed on Mar. 23, 2005.

(51) Int. Cl. A01K 39/012

(52) U.S. Cl. 119/464; 119/477

(57) ABSTRACT

A birdcage feeder for feeding a bird includes a feeding device that holds a quantity of feed for consumption by the bird, a base having a retaining portion for retaining the feeding device and a feeding portion for receiving feed from the feeding device. The feeding portion is disposed substantially on the inside of a birdcage and the feeding device is disposed outside of the birdcage. A passageway is wider than a spacing between two adjacent wires of a wirewall for passing feed from the feeding device to the feeding portion.

### CROSS-REFERENCE TO RELATED APPLICATIONS

This application is a continuation-in-part of and claims priority to U.S. Ser. No. 11/542,615 filed on Oct. 3, 2006, which is pending and which is herein incorporated by reference in its entirety for all purposes.

This application is a continuation-in-part of and claims priority to U.S. Ser. No. 10/910,242 filed Aug. 3, 2004, which is pending and which is herein incorporated by reference in its entirety for all purposes.

This application is a continuation-in-part of and claims priority to U.S. Ser. No. 11/087,728 filed on Mar. 23, 2005, which is pending and which is herein incorporated by reference in its entirety for all purposes.

### BACKGROUND OF THE INVENTION

1. Field of the Invention

The present inventions relates generally to the field of birdcage feeding devices.

2. Background of the Invention

Birdcage feeders known in the art pass seeds through the bars of a wire wall of a birdcage. Thus, the spacing of the wires determines the size of the feed. For large birds, such as cockatiels and large parrots, this means that certain preferred feed having larger size, such as concentrated feed nuggets, are unable to be fed using these wall feeders.

For example, sunflower seeds and the like that are fed to larger birds such as cockatiels and other larger parrots may be provided. Feeders that pass the feed through wires are more suitable for providing smaller seeds for finches and parakeets.

Thus, owners resort to a method of placing larger feed in a cup that attaches to the inside of the cage bars or, much less preferable, on a cage floor. Unfortunately, this means that the user has to reach inside the cage to place the larger feed and more importantly to remove sullied feeders for cleaning.

For some users, this is an uncomfortable and undesired way to provide feed. Thus, what is needed is a feeder that permits larger feed to be provided to the resident bird of a birdcage.

### SUMMARY OF THE INVENTION

These and other needs are met by the present invention.

Therein, in accordance with one or more embodiments of the present invention, a birdcage feeder for feeding a bird includes a feeding device that holds a quantity of feed for consumption by the bird, a base having a retaining portion for retaining the feeding device and a feeding portion for receiving feed from the feeding device. The feeding portion is disposed substantially on the inside of a birdcage and the feeding device is disposed outside of the birdcage. A passageway is wider than a spacing between two adjacent wires of a wirewall for passing feed from the feeding device to the feeding portion.

Furthermore, the birdcage feeder is disposed through a door opening of a birdcage and the feeding portion comprises a detent for retaining a portion of the door.

The feeding portion may include a plurality of guard walls for preventing hulls from being flung from the feeding portion, wherein at least one of the plurality of guard walls comprising a detent for retaining a portion of a door of a birdcage.

In accordance with one or more embodiments of the present invention, a birdcage feeder for mounting at least partially through a door of a birdcage includes a base having a retaining portion and a feeding portion, the feeding portion for making feed available for a bird, the feeding portion being disposed substantially inside the birdcage, the retaining portion being disposed outside of the birdcage; and the feeding portion comprising a detent for retaining a portion of the door.

Furthermore, the birdcage feeder includes a feeding device for providing a supply of feed and a passageway between the retaining portion and the feeding portion for permitting the feed to move from the retaining portion to the feeding portion. The passageway has a width at least greater than a spacing between adjacent wires in a wirewall of the birdcage.

### BRIEF DESCRIPTION OF THE INVENTION

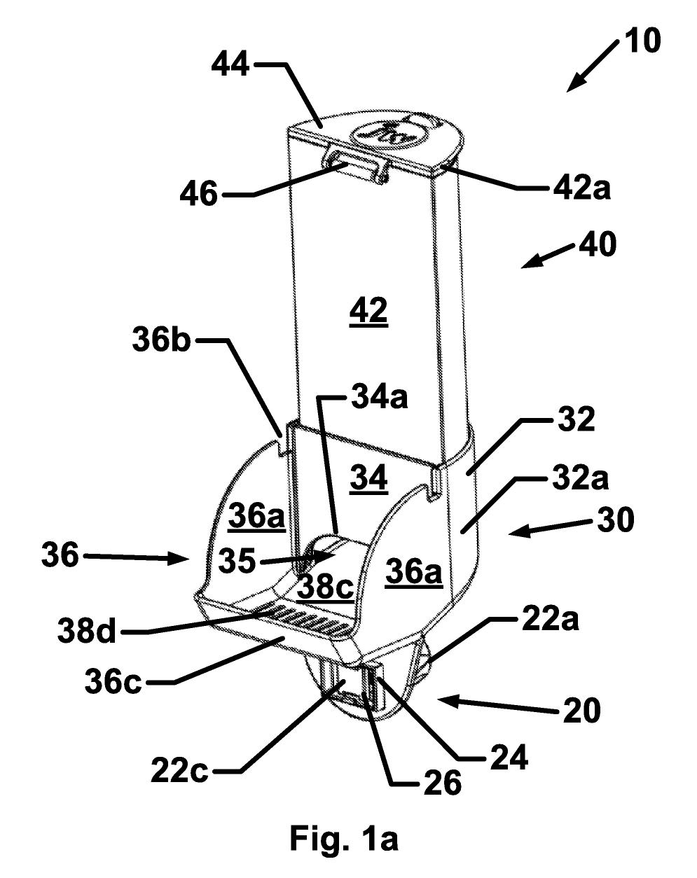

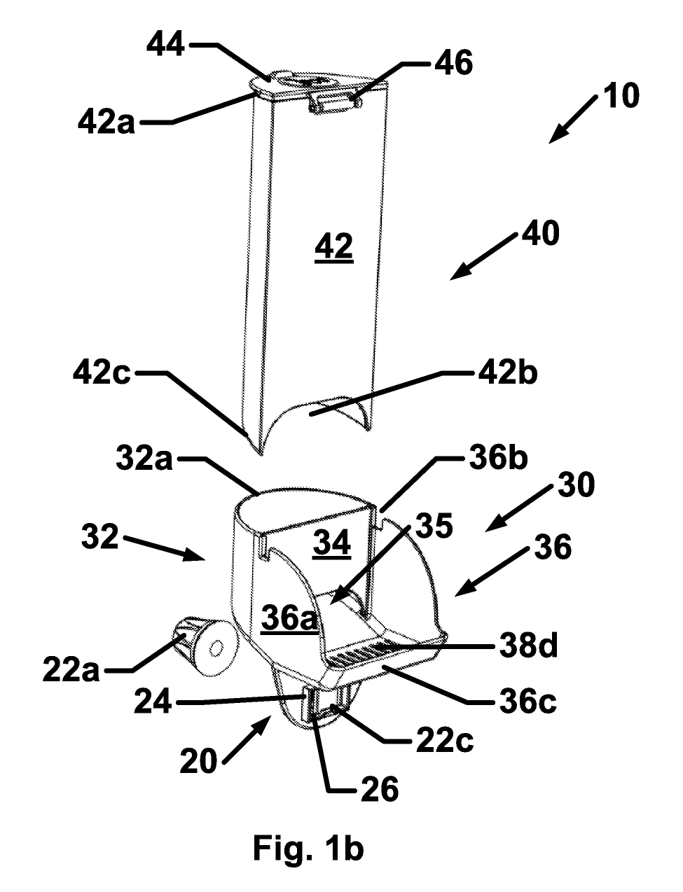

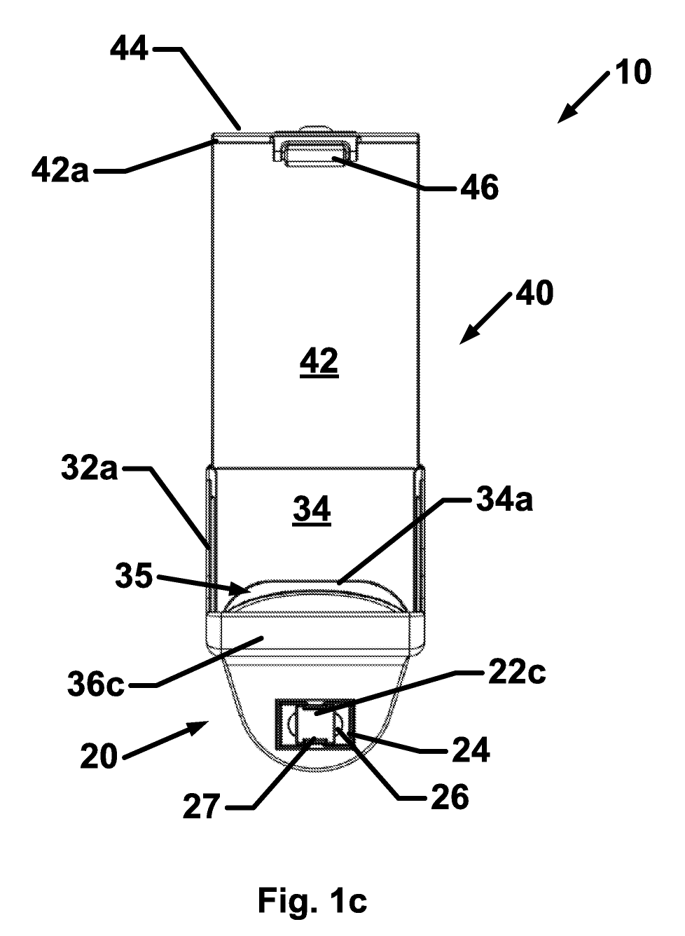

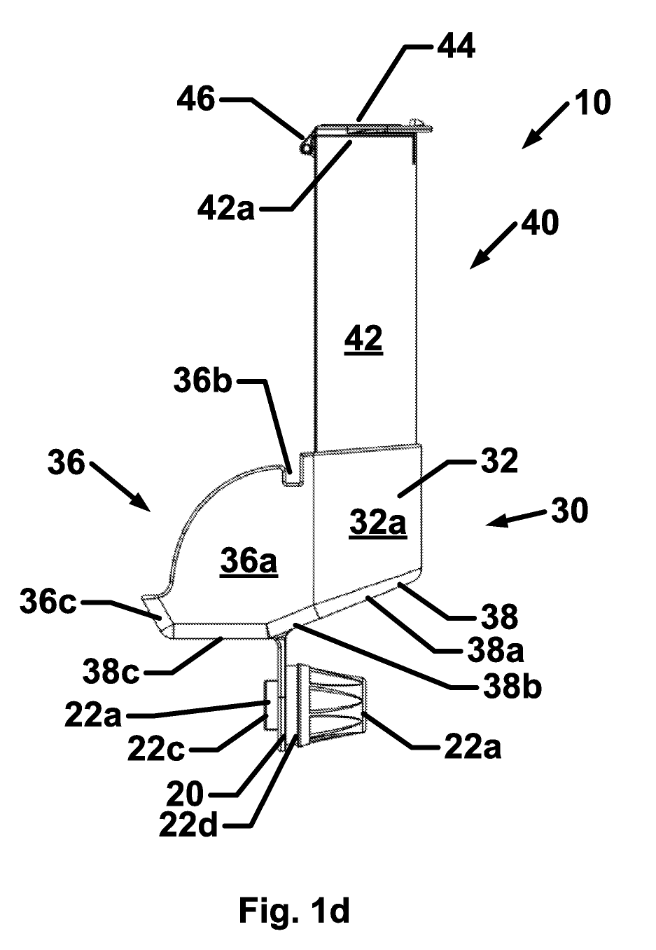

FIGS. 1a-1d are, respectively, a perspective view, an exploded view, a front view, and a side view of a birdcage feeder in accordance with one or more embodiments of the present invention.

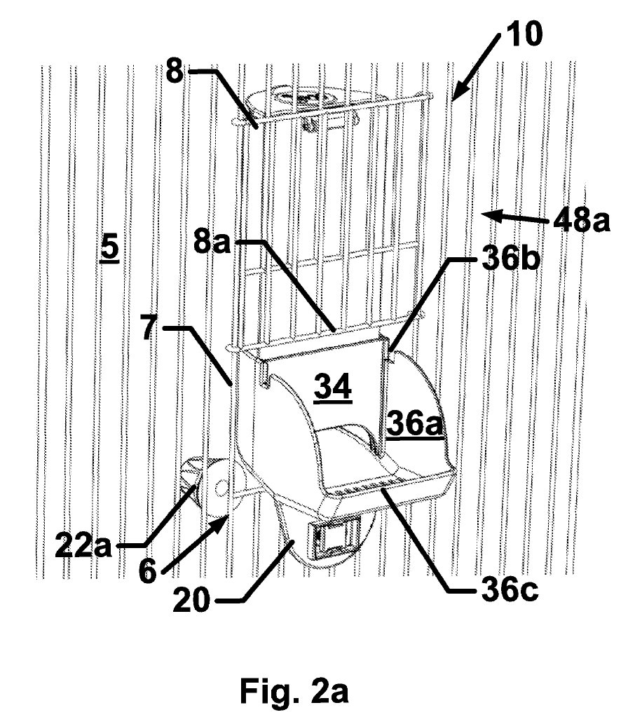

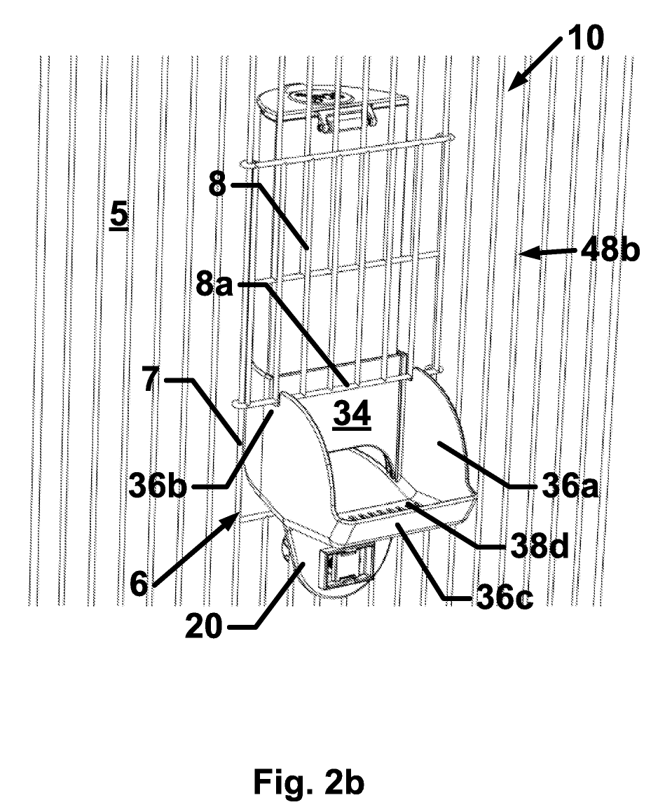

FIGS. 2a and 2b are perspective views of the birdcage feeder in a respective first door position and a second door position in accordance with one or more embodiments of the present invention.

### DETAIL DESCRIPTION OF THE INVENTION

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

FIGS. 1a-1d are, respectively, a perspective view, an exploded view, a front view, and a side view of a birdcage feeder in accordance with one or more embodiments of the present invention.

Birdcage feeder 10 is made of any durable material that preferably is both economical and easy to clean. Thus, birdcage feeder 10 may be made of a moldable plastic that is suitably colored to attract the interest of the owner and/or the resident bird. Birdcage feeder may used to provide a suitable feed, such as seeds, to the resident bird.

The birdcage feeder comprises an attachment plate 20 for securing the feeder to a birdcage 2, a base 30, and a feeding device 40 received in a portion of the base.

Attachment plate 20 is secured or is integral with the base and secures the birdcage feeder via a mating nut 22a and screw post 22b to wall 5 of the birdcage. Preferably, the birdcage feeder is mounted in a birdcage wall 5 near an opening 6, i.e., door opening, that partially defines a frame 7 of a birdcage door 8.

Preferably, the attachment plate is disposed from the underside of the base and has any suitable shape. A frame 24 is disposed on a side away from the birdcage and an opening 26, preferably in the form of an oval shape, through the attachment plate is provided within the frame.

The screw post may comprise a backing plate 22c that fits with play inside the frame. When assembled the screw post fits in opening 26 and moves laterally so that the feeder can be best mounted to the birdcage while the backing plate retain the screw post. The feeder is retained partially on wall 5 by sandwiching wall 5 between the nut and the side of the attachment plate facing wall 5.

For ease of use the frame may comprise a nub 24 that resists the backing plate from being dislodged relative to attachment plate 20 when the user positions the birdcage feeder during an attachment to wall 5.

Base 30 comprises a retaining portion 32 that retains feeding device 40, a separating wall 34, a feeding portion 36 that provides access to feed from feeding device 40, and a floor 38 disposed in the retaining and feeding portions.

Feeding device 40 is preferably press fit into the retaining portion with play. Thus, the retaining portion comprises one or more retaining walls 32a that are sized to be slightly larger than a lower periphery of the feeding device and have a shape that matches at least a first respective portion of the lower periphery of the feeding device. Thus, while the exemplary embodiments shows a particularly attractive feeding device having a first portion of the periphery as an arc and the retain wall 32a comprising a similar, albeit larger arc, the feeding device may also comprises a periphery having corners and retaining walls 32a comprising a matching shape.

The retaining portion and the retaining portion are separated by separating wall 34 that helps retain the feeding device. Thus, the separating wall 34 matches a second respective portion of the lower periphery of the feeding device and in cooperation with walls 32a retains the feeding device.

The separating wall may comprise one or more openings 34a that are suitably sized to permit feed to transfer via an opening in feeding device 40 into feeding portion 36. Preferably, opening 34a matches an opening in feeding device 40 to form a wide passageway 35.

The separating wall may be integrally molded in the base, it may be glued, or it may be removable form the base. The wall may be made of a transparent wall to enhance the visual effect of seeing the silo.

The separating wall defines the boundary between retaining walls 32a and guard walls 36a of the feeding portion. Each guard wall preferably is sized to prevent empty hulls from being flung by the resident bird and may be arched or be reduced at an end where it meets a lip wall so as to be operable with a bird's instinctive need to be able to see an approaching predator.

However, the walls are also appropriately sized to provide a suitable support to the birdcage door 8. Thus, one or more guard walls comprises a detent 36b at an end proximal to wall 5. Detent 36b is configured to retain a portion of door 8, preferably, a portion of the frame 7.

Thus, each detent is suitably disposed along a plane defined by door 8 and is spaced relative to attachment plate 20 by a distance that would approximately define the distance between wall 5 and door 8. By using, one or more washers 22d disposed on screw port 22b, the distance may be adjusted and permit the feeder to be sued on a number of different birdcage walls.

A lip wall 36c connects the guard walls at ends distal from wall 5 and defines an end of the feeding portion 36. To permit easy access to the resident bird, the lip wall is preferably angled favorably away relative to wall 5.

The base comprises floor 38 that is preferably shaped to move feed via gravity from the retaining portion, e.g., feeding device, to the feeding portion. Floor 38 includes an angled portion that comprises a first angled portion 38a under the retaining portion and a second angled portion 38b that continues preferably in the same angle from the first angled portion. The second angled portion is approximately one third of the feeding portion, as measured along a side, nearest the retaining portion. Preferably, attachment plate 20 is joined to second angled portion 38b.

Floor 38 also includes a level portion 38c disposed in the feeding portion and which comprises a grid 38d that is suitably sized to permit undesired feed material, such as husks, broken seed or partial feed particles, to fall through the grid. Thus, the feeding portion will be maintained in a cleaner state with minimal effort by the user.

Feeding device 40 preferably comprises a suitable upright body 42 that holds a predetermined amount of seeds or feed for the resident bird. The feeding device may include a lid 44 that may be joined to body 42 via any suitable means. However, especially advantageously, lid 44 is joined via a hinge 46 to body 42 such that the lid is able to rotate fully away from a top opening 42a of the body to permit easy filing. For example, lid 44 may be rotated approximately 270 degrees such that a top surface of the lid is placed against the side of the body.

Feeding device 40 also comprises an opening 42b in a sidewall of the body that permits the seed or feed to the feeding portion and preferably cooperates with opening 34a to form a passageway 35 that provides a wide opening. A bottom edge 42c of body 42 may be suitably shaped to match the angle of first angled portion 38a to help in moving feed from the retaining portion, e.g., feeding device, to the feeding portion.

Passageway 35 is preferably configured to extend from one guard wall 36a to another guard wall 36a. Passageway 35, e.g., opening 42b, e.g., opening 34, may have a width that is at least wider than the spacing between two adjacent regularly spaced wires.

Preferably, passageway 35 is greater than the spacing between the distance between the first and third wires of consecutive wires in a wirewall or a door. Passageway 35 may have any suitable height to pass the requisite feed size for a large bird through the passageway.

FIGS. 2a and 2b are perspective views of the birdcage feeder in a respective first door position and a second door position in accordance with one or more embodiments of the present invention.

In use, birdcage feeder 10 is mounted in opening 6 by first passing attachment plate 20 and a portion of base 30 through opening 6 into the interior of the birdcage. Therein, door 8 is in a first position 48a where the door is open. The birdcage feeder is secured as a whole or in part via screwpost 22b and nut 22a by sandwich wall 5, birdcage door 8 may be lowered from first position 48a to second position 48b where the door is closed relative to the birdcage feeder, wherein a lower edge 8a of the door may be securely retained in one or more detents 36b. In effect, one or more guard walls 36a securely maintain the door in a position 48b, which is open relative to a normally closed position, yet closed enough to prevent a bird from leaving the cage.

In this manner, the space open is reduced and the birdcage door helps to secure birdcage feeder 10 to the birdcage. This also mounts substantially all of feeding portion 36 from detent 36b to lip wall 36c inside the birdcage.

Since feeder 10 is used in the door, openings 42b, e.g., opening 34a, may be substantially larger than a feeder mounted on a birdcage wall that passes the feed, e.g., seed, between the wires of the cage.

When feeding device 40 needs to restocked by the user, the user only needs to open the lid via the hinge to refill the feeding device.

Thus, larger feed may be provided to the resident bird using feeder 10 and consequently larger birds that require larger feed, for example, sunflower seeds and the like that are fed may be fed to larger birds such as cockatiels and other larger parrots in an easier manner without opening the door.

A system and method has been shown in the above embodiments for the effective implementation of a birdcage feeding device. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by size, materials, or specific manufacturing techniques. The design and shape of the seed chamber, holder, and seed cup should not be limited to those shown in the figures such that they perform the same function and method of attachment to the cage. Finally, the type of fastener and cap construction and method for locking the devices together such that the birdcage watering device is secured to the cage should also not be limited to the screw fastener as shown in the figures.

What is claimed is:

1. A birdcage feeder for feeding a bird, the birdcage feeder comprising:
a feeding device that holds a quantity of feed for consumption by the bird;
a base comprising a retaining portion for retaining the feeding device and a feeding portion for receiving feed from the feeding device,
the feeding portion disposed substantially on the inside of a birdcage and the feeding device disposed outside of the birdcage,
a passageway wider than a spacing between two adjacent wires of a wirewall for passing feed from the feeding device to the feeding portion.

2. The birdcage feeder of claim 1, wherein the birdcage feeder is disposed through a door opening of a birdcage, and the feeding portion comprises a detent for retaining a portion of the door.

3. The birdcage feeder of claim 1, wherein the feeding portion comprises a plurality of guard walls for preventing hulls from being flung from the feeding portion, at least one of the plurality of guard walls comprising a detent for retaining a portion of a door of a birdcage.

4. The birdcage feeder of claim 1, wherein the feeding portion comprises a floor comprising a grid for permitting undesired feed material to fall to a birdcage floor.

5. The birdcage feeder of claim 1, further comprising a separating wall for helping retain the feeding device, the separating wall and the feeding device comprising respective openings that form the passageway.

6. The birdcage feeder of claim 1, further comprising a floor having a first and a second portion, the first portion being angled to move feed by gravity from the feeding device to the feeding portion.

7. The birdcage feeder of claim 1, further comprising an attachment plate for securing the birdcage feeder to the wirewall.

8. A birdcage feeder for mounting at least partially through a door of a birdcage, the birdcage feeder comprising:
a base comprising a retaining portion and a feeding portion, the feeding portion for making feed available for a bird, the feeding portion being disposed substantially inside the birdcage, the retaining portion being disposed outside of the birdcage; the feeding portion comprising a detent for retaining a portion of the door.

9. The birdcage feeder of claim 8, further comprising a feeding device for providing a supply of feed and a passageway between the retaining portion and the feeding portion for permitting the feed to move from the retaining portion to the feeding portion,
wherein the passageway comprises a width at least greater than a spacing between adjacent wires in a wirewall of the birdcage.

10. The birdcage feeder of claim 9, further comprising an angled floor portion for moving feed from the retaining portion to the feeding portion.

11. The birdcage feeder of claim 9, further comprising an attachment plate for attaching the birdcage feeder to the wirewall.

12. The birdcage feeder of claim 9, further comprising a feeding device for supplying feed, the feeding device being retained in the retaining portion.

13. The birdcage feeder of claim 12, further comprising a separating wall for helping retain the feeding device, the separating wall and the feeding device comprising respective openings that form the passageway.

14. A birdcage feeder for mounting through a door opening, the birdcage feeder comprising:
an attachment plate for attaching the birdcage feeder to a wirewall,
a base joined to the attachment plate, the base comprising a feeding portion disposed on a first side relative to the door opening and a wall comprising a detent for maintaining a door in an open position to permit feed to move from a second side relative to the door opening to the first side.

15. The birdcage feeder of claim 14, further comprising a retaining portion and a feeding device removable retained in the retaining portion, the retaining portion and the separating wall for helping retain the feeding device on the second side.

16. The birdcage feeder of claim 15, further comprising a separating wall between the retaining portion and the feeding portion, the separating wall and the feeding device comprising respective openings that form a passageway.

17. The birdcage feeder of claim 16, wherein the passageway comprises a width at least greater than a spacing between adjacent wires in the wirewall of the birdcage.

18. The birdcage feeder of claim 14, wherein the wall comprising the detent is a guard wall of the feeding portion.

19. The birdcage feeder of claim 14, further comprising a floor having a first and a second portion, the first portion being angled to move feed by gravity from the second side to the first side.

20. The birdcage feeder of claim 14, comprising a plurality of guard walls and a lip wall to hold the feed in the feeding portion.
